(19) United States
(12) Patent Application Publication
(10) Pub. No.: US 2018/0061193 A1
(43) Pub. Date: Mar. 1, 2018

(54) Instant Multimedia Interaction System With Tactile Experience, And Method Thereof

(71) Applicants: Inventec (Pudong) Technology Corporation, Shanghai (CN); Inventec Corporation, Taipei City (TW)

(72) Inventor: Zhi Guang Zhao, Shanghai (CN)

(21) Appl. No.: 15/622,626

(22) Filed: Jun. 14, 2017

(30) Foreign Application Priority Data
Aug. 24, 2016 (CN) 201610717760.3

(51) Int. Cl. G08B 6/00; G06F 3/01

(52) U.S. Cl. CPC G08B 6/00; G06F 3/016

(57) ABSTRACT

The present disclosure illustrates an instant multimedia interaction system with tactile experience and a method thereof. In the system, a tactile device is installed on a back surface of a handheld device, and the handheld device and the tactile device are communicated with each other. The handheld device may receive a tactile control instruction from a remote device and transmit the tactile control instruction to the tactile device. Each of tactile components of a tactile assembly is controlled to extend or retract according to the tactile control instruction. The tactile device provides tactile experience while the user uses the handheld device. Therefore, the technical effect of providing instant multimedia interaction with tactile experience may be achieved.

### CROSS-REFERENCE TO RELATED APPLICATION

This application claims the benefit of Chinese Patent Application No. 201610717760.3, filed Aug. 24, 2016.

### BACKGROUND OF THE INVENTION

### 1. Field of the Invention

The present disclosure relates to an instant multimedia interaction system and a method thereof, more particularly to a handheld device system capable of providing tactile experience, and a method thereof.

2. Description of the Related Art

In recent years, remote instant multimedia interaction technology is full developed, and existing instant multimedia interaction technology may provide user with visual feeling, auditory feeling, and so on, but still lacks tactile feeling. For this reason, the application field of existing instant multimedia interaction technology is limited.

Therefore, what is need is to develop an instant multimedia interaction system to solve the conventional technology problem that the existing instant multimedia interaction technology is unable to provide the user with tactile experience.

### SUMMARY OF THE INVENTION

In order to solve aforementioned conventional technology problem that the conventional instant multimedia interaction technology is unable to provide the user with tactile experience, the present disclosure is to provide an instant multimedia interaction system with tactile experience and a method thereof.

According to an embodiment, the present disclosure provides an instant multimedia interaction system with tactile experience, and the system includes a handheld device and a tactile device installed on a back surface of the handheld device. The handheld device may include a receiving component and a transmitting component. The tactile device may include a communication component and a tactile assembly.

The receiving component is configured to receive a tactile control instruction from a remote device or from an application program which is installed in the handheld device. The transmitting component is configured to transmit the tactile control instruction.

The communication component is configured to interconnect with the handheld device, and receive the tactile control instruction from the transmitting component. The tactile assembly includes multiple tactile components distributed on a surface of the tactile device. The tactile assembly is configured to separately control the tactile components to extend or retract according to the tactile control instruction, thereby providing the user with the tactile experience while the user holds and uses the handheld device.

According to an embodiment, the present disclosure provides an instant multimedia interaction method with tactile experience, and the method includes following steps:

First, providing a handheld device and a tactile device which is installed on a back surface of the handheld device, and interconnecting the handheld device and the tactile device, wherein the tactile device comprises a tactile assembly comprising multiple tactile components distributed on a surface of the tactile device; next, in the handheld device, receiving a tactile control instruction from a remote device or from an application program installed in the handheld device; next, transmitting the tactile control instruction from the handheld device to the tactile device; finally, separately controlling, by the tactile assembly, the tactile components to extend or retract according to the tactile control instruction, thereby providing the user with tactile experience while the user holds and uses the handheld device.

According to aforementioned content, the difference between the present disclosure and the conventional technology is that, in the system of the present disclosure, the tactile device is installed on the back of the handheld device and interconnected with the handheld device, and includes the tactile assembly including multiple tactile components distributed on the surface of the tactile device, and after the handheld device receives the tactile control instruction from the remote device, the handheld device transmits the tactile control instruction to the tactile device, and the tactile assembly separately controls the tactile components to extend or retract according to the tactile control instruction, thereby providing the user with tactile experience while the user holds and uses the handheld device.

By aforementioned technical means, the present disclosure may achieve the technical effect of providing instant multimedia interaction with tactile experience.

### BRIEF DESCRIPTION OF THE DRAWINGS

The structure, operating principle and effects of the present disclosure will be described in detail by way of various embodiments which are illustrated in the accompanying drawings.

FIG. 1 is a block diagram of an instant multimedia interaction system with tactile experience, in accordance with the present disclosure.

FIG. 2A is an exploded view of the instant multimedia interaction system with tactile experience, in accordance with the present disclosure.

FIG. 2B is a 3D assembled view of the instant multimedia interaction with tactile experience, in accordance with the present disclosure.

FIG. 2C is a schematic view showing a pattern controlled by the tactile device of the instant multimedia interaction system of the present disclosure.

FIG. 3 is a flowchart showing the steps in an operation of an instant multimedia interaction method with tactile experience, in accordance with the present disclosure.

FIG. 4 is an architecture view of the instant multimedia interaction system with tactile experience, in accordance with the present disclosure.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present invention. As used herein, the term “or” includes any and all combinations of one or more of the associated listed items.

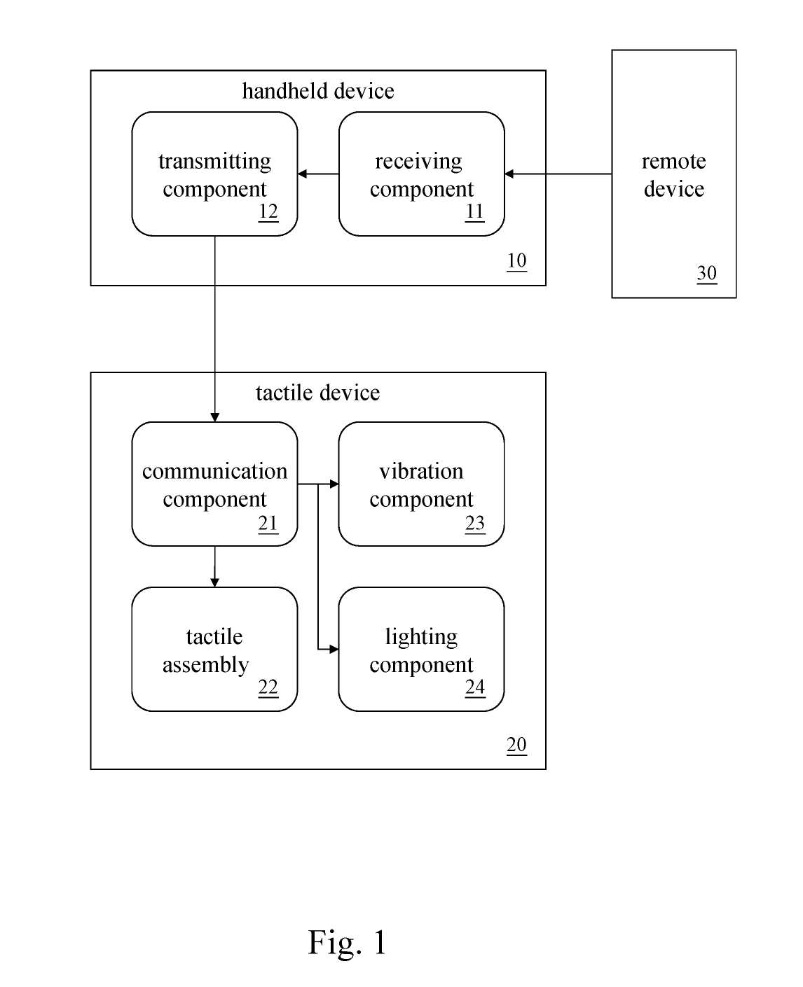

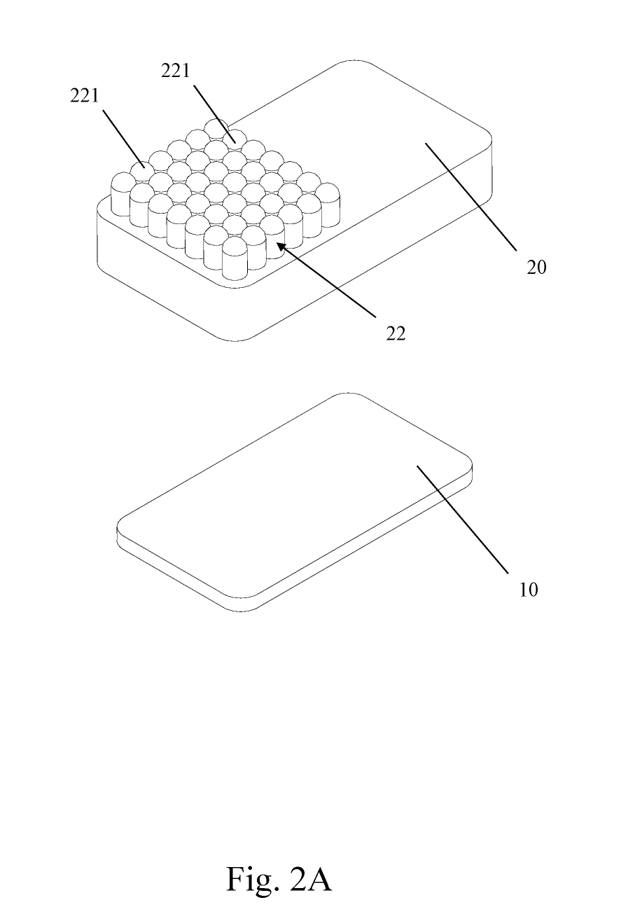

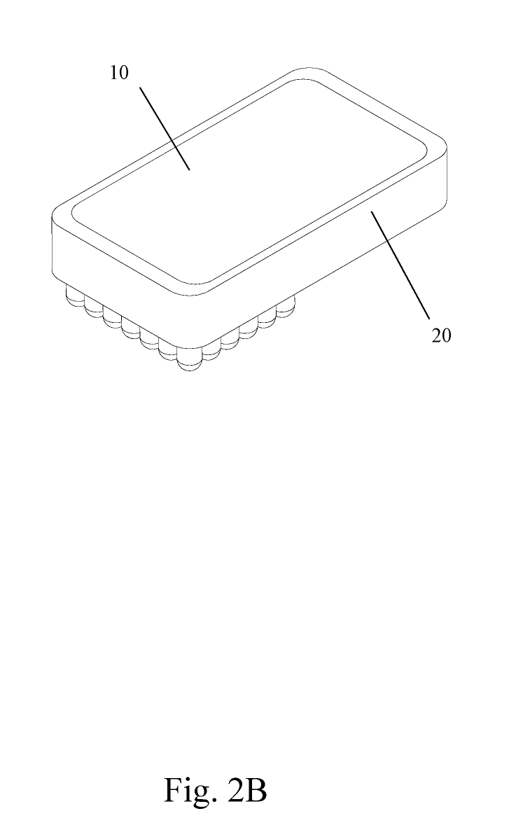

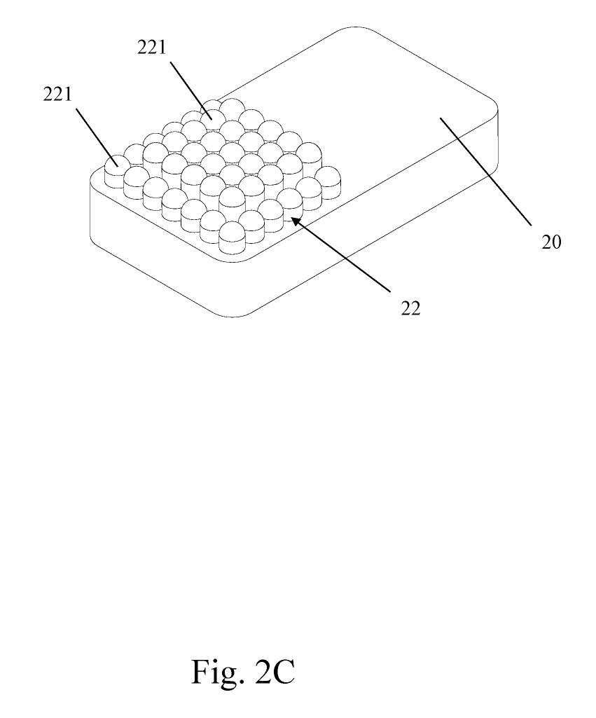

The following describes the instant multimedia interaction system with the present disclosure in reference with FIGS. 1, 2A and 2B. FIG. 1 is a block diagram the instant multimedia interaction system of the present disclosure; FIG. 2A is an exploded view of the instant multimedia interaction system of the present disclosure; and FIG. 2B is a 3D assembled view of the instant multimedia interaction system of the present disclosure.

The instant multimedia interaction system includes a handheld device 10 and a tactile device 20 installed on a back of the handheld device 10. The handheld device 10 may include a receiving component 11 and a transmitting component 12. The tactile device 20 may include a communication component 21 and a tactile assembly 22.

The tactile assembly 22 includes multiple tactile components 221 which are distributed on a surface of the tactile device 20. As shown in FIGS. 2A and 2B, the tactile assembly 22 is disposed on an area of the surface of the tactile device 20, but this example is merely for schematic illustration and the application field of the present disclosure is not limited thereto. In fact, the number of the tactile assembly may be multiple and the tactile assemblies 22 may separately be disposed at multiple areas of the surface of the tactile device 20, or the tactile assembly 22 is disposed on whole surface of the tactile device 20.

The tactile device 20 is installed on the back of the handheld device 10, and is configured to communicate with the handheld device 10 through the communication component 21 by near field communication (NFC), Bluetooth, Wi-Fi, an adaptor and so on. However, these examples are merely for exemplary illustration and the application field of the present disclosure is not limited thereto.

After the handheld device 10 receives a tactile control instruction from a remote device 30 by Wi-Fi, 3rd-generation communication technology standards (3G), fourth generation of mobile phone mobile communication technology standards (4G), and so on, the handheld device 10 may transmit the tactile control instruction to the tactile device 20 through the transmitting component 12 by NFC, Bluetooth, Wi-Fi, the adaptor and so on. Aforementioned examples are merely for exemplary illustration, but the application field of the present disclosure is not limited thereto.

The handheld device 10 may also receive the tactile control instruction from an application program installed therein, through the receiving component 11, and transmit the tactile control instruction to the tactile device 20 through the transmitting component 12 of the handheld device 10 by NFC, Bluetooth, Wi-Fi, the adaptor and so on. Aforementioned examples are merely for exemplary illustration, but the application field of the present disclosure is not limited thereto.

The communication component 21 of the tactile device 20 receives the tactile control instruction from the transmitting component 12 of the handheld device 10 through NFC, Bluetooth, Wi-Fi, the adaptor and so on. Next, the tactile assembly 22 of the tactile device 20 respectively controls the tactile components 221 to extend or retract according to the tactile control instruction, thereby providing the user with tactile experience while the user holds and uses the handheld device 10.

Besides providing the tactile experience for the user while the user holds and uses the handheld device 10, the tactile assembly 22 of the tactile device 20 may control extension or retraction of each of the tactile components 221 to form a specific pattern, as shown in FIG. 2C, which shows a pattern controlled by the tactile device of the instant multimedia interaction system of the present disclosure. FIG. 2C shows a square pattern for illustration, but the application field of the present disclosure is not limited thereto. For example, the specific pattern formed by the tactile components 221 may be in a circular shape, a diamond shape, an array including protrusions and recesses, and so on.

The tactile device 20 may include a vibration component 23. When the communication component 21 of the tactile device 20 receives a vibration control instruction from the handheld device 10, the vibration component 23 of the tactile device 20 is controlled to vibrate according to the vibration control instruction.

The vibration control instruction may be generated by the remote device 30 and then transmitted to the handheld device 10, and the communication component 21 of the tactile device 20 may receive the vibration control instruction from the handheld device 10;

alternatively, the vibration control instruction may be generated by the handheld device 10, and the communication component 21 of the tactile device 20 may receive the vibration control instruction from the handheld device 10.

The tactile device 20 may include a lighting component 24. When the communication component 21 of the tactile device 20 receives a lighting control instruction from the handheld device 10, the lighting component 24 of the tactile device 20 is controlled to emit light according to the lighting control instruction.

The lighting control instruction may be generated by the remote device 30 and then transmitted to the handheld device 10, and the communication component 21 of the tactile device 20 may receive the lighting control instruction from the handheld device 10; alternatively, the lighting control instruction may be generated by the handheld device 10, and the communication component 21 of the tactile device 20 may receive the lighting control instruction from the handheld device 10.

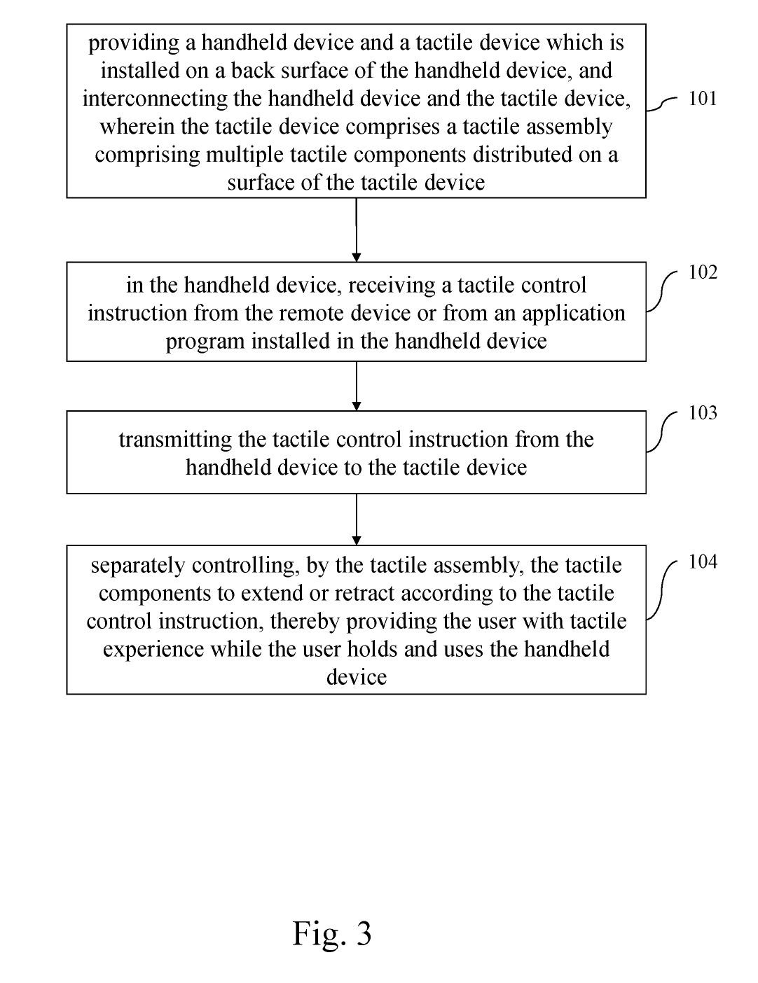

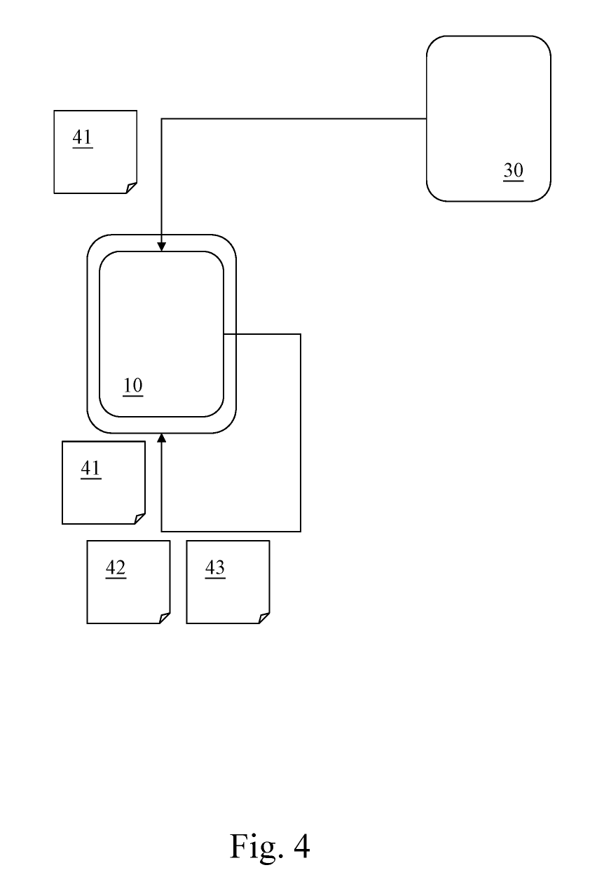

The following refers to an embodiment for illustration of operation of the system and method of the present disclosure in reference with FIGS. 1, 3 and 4. FIG. 3 is a flowchart showing the steps in an operation of an instant multimedia interaction method with tactile experience, in accordance with the present disclosure. FIG. 4 is a schematic view of architecture of the instant multimedia interaction system of the present disclosure.

In a step 101, the tactile device 20 is installed on the back of the handheld device 10, and the tactile device 20 may include the tactile assembly 22 including the multiple tactile components 221 distributed on the surface of the tactile device 20. The tactile device 20 is interconnected with the handheld device 10 by the communication component 21 through NFC, Bluetooth, Wi-Fi, the adaptor and so on. The aforementioned examples are merely for exemplary illustration, and the application field of the present disclosure is not limited thereto.

In a step 102, the handheld device 10 receives the tactile control instruction 41 from the remote device 30 through the receiving component 11 by Wi-Fi, 3G, 4G, and so on. In a step 103, the transmitting component 12 of the handheld device 10 transmits the tactile control instruction 41 to the tactile device 20 by NFC, Bluetooth, Wi-Fi, the adaptor, and so on. The aforementioned examples are merely for exemplary illustration, and the application field of the present disclosure is not limited thereto.

In other embodiment, in the step 102, the receiving component 11 of the handheld device 10 may receive the tactile control instruction 41 from the application program installed in the handheld device 10, and in the step 103, the transmitting component 12 of the handheld device 10 may transmit the tactile control instruction to the tactile device 20 by NFC, Bluetooth, Wi-Fi, the adaptor, and so on; however, these examples are merely for exemplary illustration, and the application field of the present disclosure is not limited thereto.

In a step 104, the communication component 21 of the tactile device 20 may receive the tactile control instruction 41 from the transmitting component 12 of the handheld device 10 by NFC, Bluetooth, Wi-Fi, the adaptor and so on. Next, the tactile assembly 22 of the tactile device 20 separately controls the tactile components 221 to extend or retract according to the tactile control instruction 41, thereby providing the user with tactile experience while the user holds and uses the handheld device 10.

Besides providing the user with tactile experience while the user holds and uses the handheld device 10, the tactile assembly 22 of the tactile device 20 may also separately control the tactile components 221 to extend or retract to form the specific pattern according to the tactile control instruction 41.

The tactile device 20 may include the vibration component 23. After the communication component 21 of the tactile device 20 receives the vibration control instruction 42 from the handheld device 10, the vibration component 23 of the tactile device 20 is controlled to vibrate according to the vibration control instruction 42.

The vibration control instruction may be generated by the remote device 30 and then transmitted to the handheld device 10, and the communication component 21 of the tactile device 20 may receive the vibration control instruction 42 from the handheld device 10; alternatively, the vibration control instruction 42 may be generated by the handheld device 10, and the communication component 21 of the tactile device 20 may receive the vibration control instruction 42 from the handheld device 10.

The tactile device 20 may include the lighting component 24. After the communication component 21 of the tactile device 20 receives the lighting control instruction 43 from the handheld device 10, the lighting component 24 of the tactile device 20 is controlled to emit light according to the lighting control instruction 43.

The lighting control instruction 43 may be generated by the remote device 30 and then transmitted to the handheld device 10, and the communication component 21 of the tactile device 20 may receive the lighting control instruction 43 from the handheld device 10; alternatively, the lighting control instruction 43 may be generated by the handheld device 10, and the communication component 21 of the tactile device 20 may receive the lighting control instruction 43 from the handheld device 10.

To summarize, the difference between the present disclosure and the conventional technology is that, in the system of the present disclosure, the tactile device is installed on the back of the handheld device and interconnected with the handheld device, and includes the tactile assembly including the multiple tactile components distributed on the surface of the tactile device, and after the handheld device receives the tactile control instruction from the remote device, the handheld device transmits the tactile control instruction to the tactile device, and the tactile assembly separately controls the tactile components to extend or retract according to the tactile control instruction, thereby providing the user with tactile experience while the user holds and uses the handheld device.

By aforementioned technical means, the conventional technology problem that the existing instant multimedia interaction lacks tactile experience may be solved, and the technical effect of providing instant multimedia interaction with tactile experience may be achieved.

The present disclosure disclosed herein has been described by means of specific embodiments. However, numerous modifications, variations and enhancements can be made thereto by those skilled in the art without departing from the spirit and scope of the invention set forth in the claims.

What is claimed is:

1. An instant multimedia interaction system with tactile experience, comprising:
a handheld device, comprising:
a receiving component configured to receive a tactile control instruction from a remote device or from an application program which is installed in the handheld device; and
a transmitting component configured to transmit the tactile control instruction; and
a tactile device installed on a back surface of the handheld device, and comprising:
a communication component configured to interconnect with the handheld device, and receive the tactile control instruction from the transmitting component; and
a tactile assembly comprising multiple tactile components distributed on a surface of the tactile device, and configured to separately control the tactile components to extend or retract according to the tactile control instruction, thereby providing the user with the tactile experience while the user holds and uses the handheld device.

2. The instant multimedia interaction system according to claim 1, wherein the tactile assembly further separately controls the multiple tactile components to extend or retract to form a pattern according to the tactile control instruction.

3. The instant multimedia interaction system according to claim 1, the tactile device further comprises a vibration component, and after the communication component receives a vibration control instruction from the handheld device, the vibration component is controlled to vibrate according to the vibration control instruction.

4. The instant multimedia interaction system according to claim 1, wherein the tactile device further comprises a lighting component, and after the communication component receives a lighting control instruction from the handheld device, the lighting component is controlled to emit light according to the lighting control instruction.

5. The instant multimedia interaction system according to claim 1, wherein the receiving component receives the tactile control instruction from the remote device or from the application program installed in the handheld device by Wi-Fi, 3rd generation mobile communication technology (3G), fourth generation of mobile communication technology standards (4G);
wherein the tactile device is interconnected with the handheld device by near field communication (NFC), Bluetooth, Wi-Fi, or an adaptor.

6. An instant multimedia interaction method with tactile experience, comprising:
providing a handheld device and a tactile device which is installed on a back surface of the handheld device, and interconnecting the handheld device and the tactile device, wherein the tactile device comprises a tactile assembly comprising multiple tactile components distributed on a surface of the tactile device;
in the handheld device, receiving a tactile control instruction from a remote device or from an application program installed in the handheld device;
transmitting the tactile control instruction from the handheld device to the tactile device; and
separately controlling, by the tactile assembly, the tactile components to extend or retract according to the tactile control instruction, thereby providing the user with tactile experience while the user holds and uses the handheld device.

7. The instant multimedia interaction method according to claim 6, further comprising:
controlling the tactile components to extend or retract to form a pattern according to the tactile control instruction.

8. The instant multimedia interaction method according to claim 6, further comprising:
in the tactile device, receiving a vibration control instruction from the handheld device; and
controlling a vibration component of the tactile device to vibrate according to the vibration control instruction.

9. The instant multimedia interaction method according to claim 6, further comprising:
in the tactile device, receiving a lighting control instruction from the handheld device; and
controlling a lighting component of the tactile device to emit light according to the lighting control instruction.

10. The instant multimedia interaction method according to claim 6, wherein the handheld device receives the tactile control instruction from the remote device or from the application program installed in the handheld device, by Wi-Fi, 3G, or 4G;
wherein the tactile device is interconnected with the handheld device by NFC, Bluetooth, Wi-Fi, or an adaptor.
